(19) United States
(12) Patent Application Publication
(10) Pub. No.: US 2016/0109617 A1
(43) Pub. Date: Apr. 21, 2016

(54) INFORMATION TRANSMISSION APPARATUS, WEATHER CONDITION ACQUISITION SYSTEM, SERVER APPARATUS, INFORMATION TRANSMISSION METHOD AND PROGRAM

(71) Applicant: PIONEER CORPORATION, Kanagawa (JP)

(72) Inventors: Kimihiko HIROI, Kodaira-shi, Tokyo-to (JP); Katsuhiko TAKAHASHI, Kawagoe-shi, Saitama-ken (JP); Kenichiro YANO, Kawasaki-shi, Kanagawa-ken (JP); Toshiyuki KOMURO, Kawasaki-shi, Kanagawa-ken (JP); Masaki HIROTSU, Kawasaki-shi, Kanagawa-ken (JP); Yuya YANO, Kawagoe-shi, Saitama-ken (JP); Arihito TERAO, Kawagoe-shi, Saitama-ken (JP); Ryu OSHIMI, Kawagoe-shi, Saitama-ken (JP); Mitsuharu SUZUKI, Chiyoda-ku, Tokyo-to (JP); Keisuke YASUNAKA, Kawagoe-shi, Saitama-ken (JP)

(73) Assignee: PIONEER CORPORATION, Kanagawa (JP)

(21) Appl. No.: 14/897,356

(22) PCT Filed: Jun. 11, 2013
(86) PCT No.: PCT/JP2013/066117

§ 371 Date: Dec. 10, 2015

(51) Int. Cl. G01W 1/00; G06K 9/00

(52) U.S. Cl. CPC G01W 1/00; G06K 9/00791

(57) ABSTRACT

This information transmission apparatus that moves with a mobile body is provided with: a photographing means; a weather information generating means which generates, on the basis of a mobile body wiper image photographed by means of the photographing means, weather information that indicates weather conditions of a location where the photographing means photographed the image; an acquisition means that acquires positional information of the photographing location; and a transmission means, which transmits the weather information and the positional information.

### TECHNICAL FIELD

The present invention relates to a technical field of generating and transmitting weather information.

### BACKGROUND TECHNIQUE

A technique of this kind is proposed in Patent Reference 1, for example. Patent Reference 1 discloses a technique of generating and transmitting weather information indicating that rain is falling, by utilizing a rainfall detection sensor applied to an automatic wiper which operates at the time of rainfall or a detection sensor which detects that the wiper is operating.

### PRIOR ART DOCUMENT

### Patent Document

Patent Reference 1: Japanese Patent Application Laid-open under No. H11-223674

### DISCLOSURE OF INVENTION

### Problem to be Solved by the Invention

By the technique described in Patent Reference 1, it is necessary to use a special detection means, such as a sensor, for generating the weather information. However, it is convenient if the weather information can be generated without using such a special detection means.

The above is an example of the problem to be solved by the present invention. It is a main object of the present invention to provide an information transmission apparatus capable of appropriately generating weather information with simple configuration.

### Means for Solving the Problem

In an invention described in claims, an information transmission apparatus which moves with a movable body, comprises: an imaging unit; a weather information generation unit which generates weather information indicating weather condition at an imaging place by the imaging unit, based on images of a wiper of the movable body taken by the imaging unit; an acquisition unit which acquires position information of the imaging place; and a transmission unit which transmits the weather information and the position information.

In another invention described in claims, a weather condition acquisition system comprises an information transmission apparatus which moves with a movable body; and a server apparatus communicably connected with the information transmission apparatus, wherein the information transmission apparatus comprises: an imaging unit; a weather information generation unit which generates weather information indicating weather condition at an imaging place by the imaging unit, based on images of a wiper of the movable body taken by the imaging unit; an acquisition unit which acquires position information of the imaging place; and a transmission unit which transmits the weather information and the position information, and wherein the server apparatus comprises: a receiving unit which receives the weather information and the position information from a plurality of the information transmission apparatuses; a storage unit which stores map data; and a weather map generation unit which generates a map of weather condition associated with the map data, based on the weather information and the position information.

In still another invention described in claims, a server apparatus comprises: a receiving unit which receives, from an information transmission apparatus which moves with a movable body, wiper information on movement of a wiper, generated based on images of a wiper of the movable body taken by the information transmission apparatus, and position information of a place where the image of the wiper is taken; and a detection unit which detects weather condition at the place where the image of the wiper is taken, based on the wiper information and the position information.

In still another invention described in claims, an information transmission method executed by an information transmission apparatus which includes an imaging unit and which moves with a movable body, comprises: a weather information generation process which generates weather information indicating weather condition at an imaging place by the imaging unit, based on images of a wiper of the movable body taken by the imaging unit; an acquisition process which acquires position information of the imaging place; and a transmission process which transmits the weather information and the position information.

In still another invention described in claims, a program executed by an information transmission apparatus which includes an imaging unit and a computer and which moves with a movable body, the program making the computer function as: a weather information generation unit which generates weather information indicating weather condition at an imaging place by the imaging unit, based on images of a wiper of the movable body taken by the imaging unit; an acquisition unit which acquires position information of the imaging place; and a transmission unit which transmits the weather information and the position information.

In still another invention described in claims, the recording medium stores the above-mentioned program.

### BRIEF DESCRIPTION OF THE DRAWINGS

FIG. 1 illustrates a schematic configuration of a system realized by a server apparatus and a navigation apparatus.

FIG. 2 is a block diagram illustrating schematic configuration of the server apparatus and the navigation apparatus.

FIG. 3 is a diagram illustrating an installed position and an imaging direction of a camera.

FIG. 4 is a flowchart illustrating a whole processing according to a first embodiment.

FIG. 5 is a diagram for explaining an example of a method of detecting a wiper image candidate.

FIGS. 6A to 6C are diagrams for explaining an example of a method of determining the wiper image candidate.

FIG. 7 is a flowchart illustrating a method of generating weather information according to a second embodiment.

FIG. 8 illustrates an example of a correction coefficient table for correcting a number of times of wiper operation.

### DETAILED DESCRIPTION OF THE PREFERRED EMBODIMENTS

According to one aspect of the present invention, there is provided an information transmission apparatus which moves with a movable body, comprising: an imaging unit; a weather information generation unit which generates weather information indicating weather condition at an imaging place by the imaging unit, based on images of a wiper of the movable body taken by the imaging unit; an acquisition unit which acquires position information of the imaging place; and a transmission unit which transmits the weather information and the position information.

In the above information transmission apparatus, the weather information indicating the weather condition at the imaging place is generated based on the image of the wiper taken by the imaging unit (e.g., camera), and the weather information is transmitted together with the position information of the imaging place. Thus, the weather information can be appropriately provided with simple configuration. Specifically, the weather information can be appropriately generated and provided by software processing without a sensor or the like installed in a vehicle.

In one mode of the above information transmission apparatus, the weather information generation unit generates the weather information based on a number of times that the wiper moves in plural images taken by the imaging unit during a predetermined time or a number of times that the wiper is included in the plural images. By this, the weather condition may be accurately judged.

In another mode of the above information transmission apparatus, preferably the weather information generation unit generates information on intensity of rainfall as the weather information.

Still another mode of the above information transmission apparatus further comprises a storage unit which stores the weather information, wherein the weather information generation unit further generates information on weather change based on current weather information generated this time and past weather information stored in the storage unit, and wherein the transmission unit transmits the weather information, the position information and the information on weather change. By this, it becomes possible to provide information indicating how the weather has changed (or that the weather has not changed).

In still another mode of the above information transmission apparatus, the transmission unit does not transmit the weather information when the movable body is travelling in a tunnel, under a viaduct or in an indoor parking. By this, it can be appropriately prevented that erroneous weather information is provided.

In still another mode of the above information transmission apparatus, when the movable body is travelling in a tunnel, under a viaduct or in an indoor parking, the transmission unit transmits information indicating that the movable body is travelling in a tunnel, under a viaduct or an indoor parking, in addition to the weather information and the position information. By this, the receiving side of the weather information can appropriately determine the weather information that is not to be adopted.

Preferably in the above information transmission apparatus, the weather information generation unit compares successive images taken by the imaging unit to specify the image, included in an area where luminance of pixels decrease more than a predetermined value, as a wiper image candidate which is a candidate for the image of the wiper.

In a preferred example, the weather information generation unit may adopt the wiper image candidate as the image of the wiper in a case where a shape of the wiper image candidate satisfies a predetermined aspect ratio.

In another preferred example, the weather information generation unit may adopt the wiper image candidate as the image of the wiper in a case where inclination of a shape of the wiper image candidate is within a predetermined angle range.

According to another aspect of the present invention, there is provided a weather condition acquisition system comprising an information transmission apparatus which moves with a movable body; and a server apparatus communicably connected with the information transmission apparatus, wherein the information transmission apparatus comprises: an imaging unit; a weather information generation unit which generates weather information indicating weather condition at an imaging place by the imaging unit, based on images of a wiper of the movable body taken by the imaging unit; an acquisition unit which acquires position information of the imaging place; and a transmission unit which transmits the weather information and the position information, and wherein the server apparatus comprises: a receiving unit which receives the weather information and the position information from a plurality of the information transmission apparatuses; a storage unit which stores map data; and a weather map generation unit which generates a map of weather condition associated with the map data, based on the weather information and the position information.

According to still another aspect of the present invention, there is provided a server apparatus comprising: a receiving unit which receives, from an information transmission apparatus which moves with a movable body, wiper information on movement of a wiper, generated based on images of a wiper of the movable body taken by the information transmission apparatus, and position information of a place where the image of the wiper is taken; and a detection unit which detects weather condition at the place where the image of the wiper is taken, based on the wiper information and the position information.

According to still another aspect of the present invention, there is provided an information transmission method executed by an information transmission apparatus which includes an imaging unit and which moves with a movable body, comprising: a weather information generation process which generates weather information indicating weather condition at an imaging place by the imaging unit, based on images of a wiper of the movable body taken by the imaging unit; an acquisition process which acquires position information of the imaging place; and a transmission process which transmits the weather information and the position information.

According to still another aspect of the present invention, there is provided a program executed by an information transmission apparatus which includes an imaging unit and a computer and which moves with a movable body, the program making the computer function as: a weather information generation unit which generates weather information indicating weather condition at an imaging place by the imaging unit, based on images of a wiper of the movable body taken by the imaging unit; an acquisition unit which acquires position information of the imaging place; and a transmission unit which transmits the weather information and the position information.

The above program may be suitably handled in a manner recorded in a recording medium.

### Embodiments

Preferred embodiments of the present invention will be described below with reference to the attached drawings.

### 1. CONFIGURATION OF APPARATUS

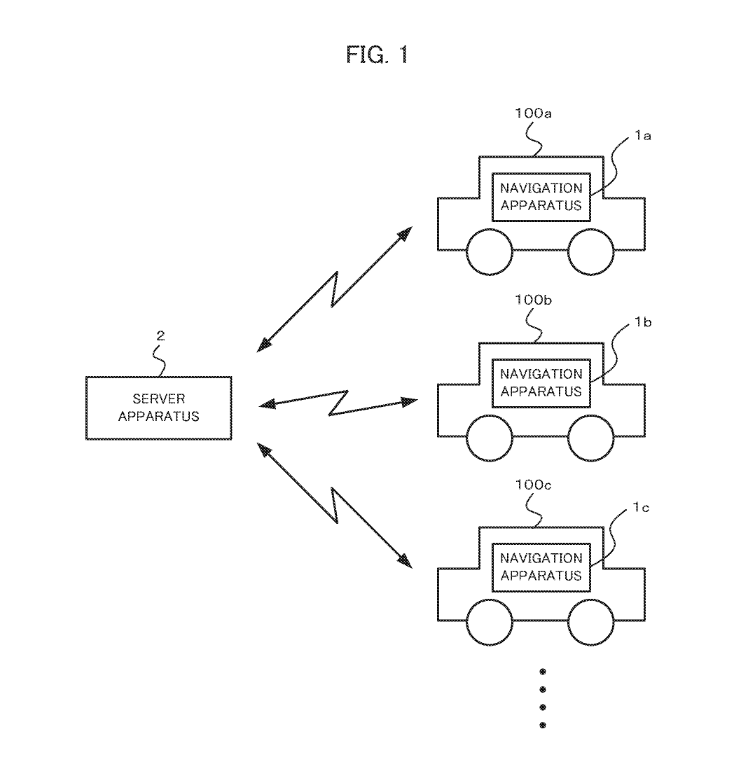

FIG. 1 illustrates a schematic configuration of a system realized by a navigation apparatus 1 and a server apparatus 2 according to an embodiment.

As illustrated in FIG. 1, the navigation apparatuses 1a to 1c (1) are installed in different vehicles 100a to 100c (100), respectively, and transmit and receive information to and from the server apparatus 2. The server apparatus 2 stores information received from the navigation apparatus 1, and transmits generated information to the navigation apparatus 1. For example, the navigation apparatus 1 may be a stationary navigation apparatus installed in the vehicle 100, a PND (Portable Navigation Device) or a cell phone such as a smartphone, and has a function of route guidance to a destination.

The navigation apparatus 1 corresponds to an example of “an information transmission apparatus” in the present invention. Also, the system including the navigation apparatus 1 and the server apparatus 2 as shown in FIG. 1 corresponds to an example of “a weather condition acquisition system” of the present invention.

While only three navigation apparatuses 1a to 1c are illustrated in FIG. 1 for convenience of explanation, four or more navigation apparatuses 1 may be applied.

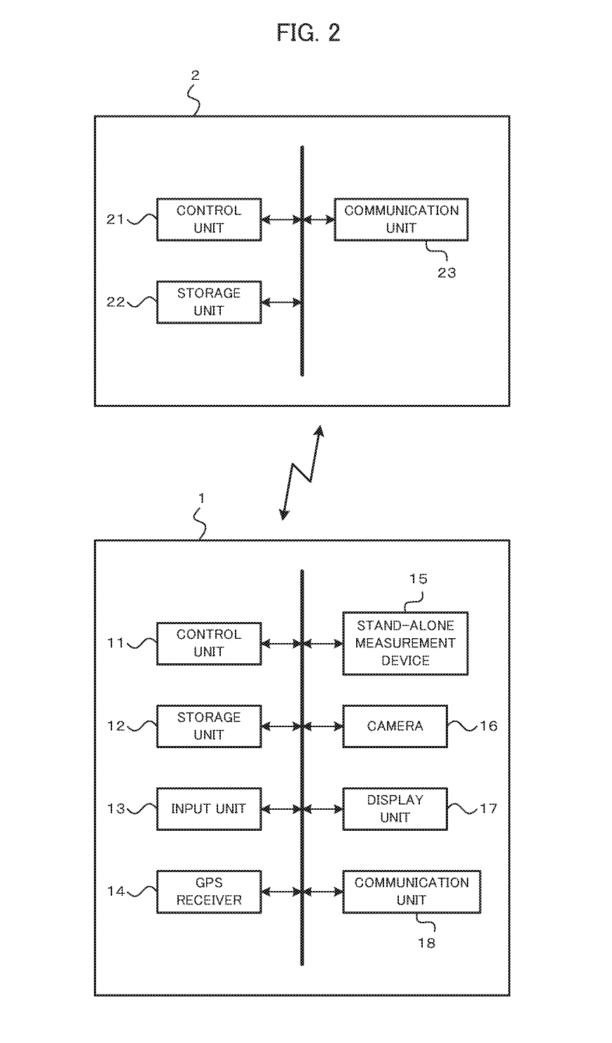

FIG. 2 is a block diagram illustrating a schematic configuration of the navigation apparatus 1 and the server apparatus 2. The navigation apparatus 1 and the server apparatus 2 are communicable with each other via a wireless network.

The navigation apparatus 1 mainly includes a control unit 11, a storage unit 12, an input unit 13, a GPS receiver 14, a stand-alone measurement device 15, a camera 16, a display unit 17 and a communication unit 18.

The storage unit 12 includes a harddisk, a ROM (Read Only Memory) and a RAM (Random Access Memory), which are not shown. The storage unit 12 stores various control programs to control the navigation apparatus 1, and provides a working area for the control unit 11. Also, the storage unit 12 stores map data, for example.

The input unit 13 is constituted by keys, switches, buttons, a remote controller or a voice input device for inputting various commands and data. In a case where the display unit 17 is constituted by a touch panel system, the touch panel provided on a display screen of the display unit 17 also functions as the input unit 13.

The GPS receiver 14 receives radio waves carrying downlink data including measurement data from a plurality of GPS satellites. The measurement data is used to detect an absolute position (uniquely the position of the vehicle 100) of the navigation apparatus 1 from the information of latitude and longitude.

The stand-alone measurement device 15 includes an acceleration sensor, an angular velocity sensor and a distance sensor, which are not shown. The acceleration sensor includes a piezoelectric element, for example, and detects the acceleration of the vehicle 100 to output acceleration data. The angular velocity sensor includes an oscillation gyroscope, for example, and detects angular velocity of the vehicle 100 at the time of changing direction to output angular velocity data and relative azimuth data. The distance sensor counts vehicle speed pulses of the pulse signal generated according to the revolution of the wheels of the vehicle 100.

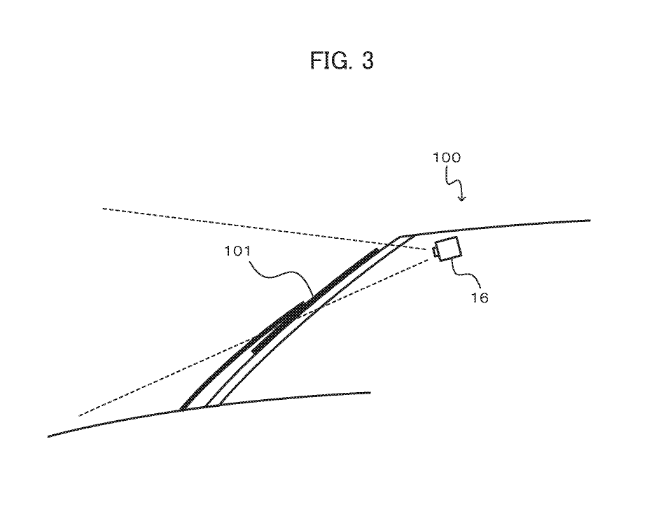

As shown in FIG. 3, the camera 16 is mounted near the ceiling of the compartment of the vehicle 100 so as to capture the front scene of the vehicle 100 as well as a part or a whole part of the wiper 101 swinging on the front glass within an imaging area. The camera 16 corresponds to an example of “an imaging unit” of the present invention. Instead of mounting the camera 16 near the ceiling, the camera 16 may be mounted on a dashboard. Also in that case, the camera 16 is mounted at the position to capture the front scene as well as a part or a whole part of the wiper 101 within an imaging area.

The display unit 17 is constituted by a liquid crystal display, for example, and displays characters and images to the user. The display unit 17 may have a touch panel.

The communication unit 18 is communicable with the server apparatus 2 via a network not shown. For example, the communication unit 18 transmits the weather information generated by the control unit 11 to the server apparatus 2. Also, the communication unit 18 receives the information transmitted from the server apparatus 2. The communication unit 18 corresponds to an example of “a transmission unit” of the present invention.

The control unit 11 includes a CPU (Central Processing Unit) not shown, and controls the navigation apparatus 1 in its entirety. In this embodiment, the control unit 11 generates the weather information indicating the weather condition of the imaging place based on the image captured by the camera 16, and makes the communication unit 18 transmit the weather information to the server apparatus 2. The control unit 11 corresponds to an example of “a weather information generation unit” and “an acquisition unit” of the present invention.

On the other hand, the server apparatus 2 mainly includes a control unit 21, a storage unit 22 and a communication unit 23.

The communication unit 23 is communicable with the navigation apparatus 1 via the network not shown. Specifically, the communication unit 23 receives the weather information transmitted from the navigation apparatus 1. Also, the communication unit 23 transmits information generated by the control unit 21 to the navigation apparatus 1. The communication unit 23 corresponds to an example of “a receiving unit” of the present invention.

The storage unit 22 includes a harddisk, a ROM and a RAM which are not shown, and stores the weather information transmitted from the plural navigation apparatuses 1. Also, the storage unit 22 stores the map data, for example.

The control unit 21 includes a CPU not shown, and controls the server apparatus 2 in its entirety. In this embodiment, the control unit 21 generates information in accordance with the weather information received from the navigation apparatus 1 via the communication unit 23. The control unit 21 corresponds to an example of “a weather map generation unit” and “a detection unit” of the present invention.

### 2. FIRST EMBODIMENT

The configuration according to the first embodiment will be described below.

2-1. Whole Processing

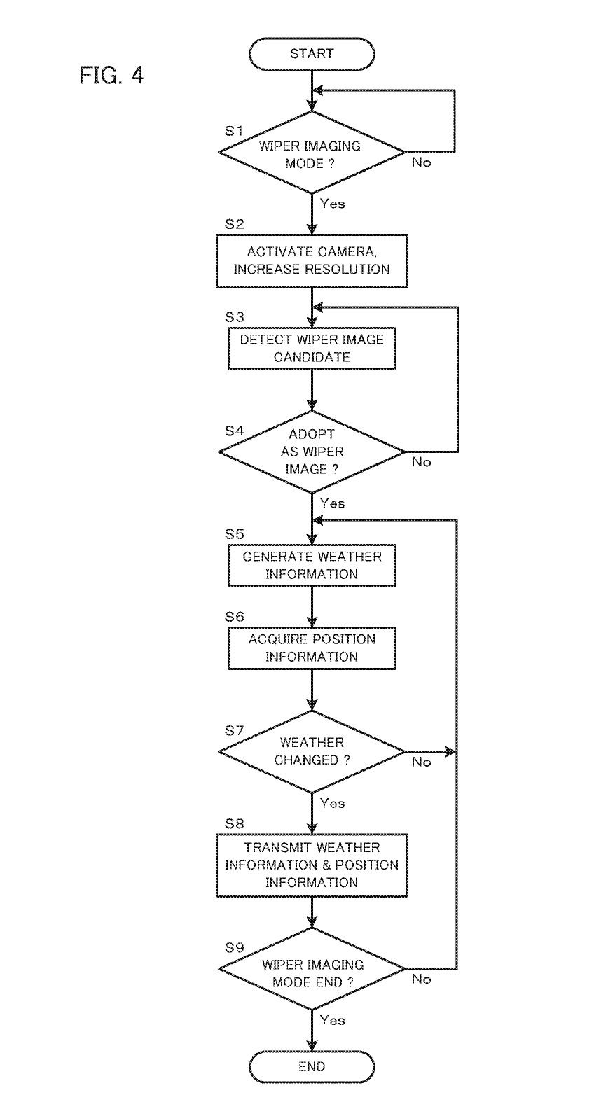

First, with reference to FIG. 4, an outline of the processing executed by the control unit 11 in the navigation apparatus 1 in the first embodiment will be described. FIG. 4 is a flowchart illustrating the whole processing according to the first embodiment. This flow is executed by the control unit 11 in the navigation apparatus 1.

First, in step S1, the control unit 11 determines whether or not the user selected the wiper imaging mode by the input unit 13. In this case, the control unit 11 makes the determination based on the signal outputted by the input unit 13. The wiper imaging mode is the mode in which the camera 16 of the navigation apparatus 1 images the wiper 101 of the vehicle 100. As described above, since the weather information is generated based on the image of the wiper 101 imaged by the camera 16 in the navigation apparatus 1 in this embodiment, the wiper imaging mode is the mode to generate the weather information in the navigation apparatus 1.

When it is determined that the user selected the wiper imaging mode (step S1: Yes), the process goes to step S2. On the contrary, when it is determined that the user does not select the wiper imaging mode (step S1: No), the process returns to step S1.

In step S2, the control unit 11 activates the camera 16 and increases the resolution of the camera 16. The reason to increase the resolution is to image the movement of the wiper with high resolution. Then, the process goes to step S3.

In step S3, the control unit 11 analyzes the captured image of the camera 16 to detect a wiper image candidate which is a candidate of the image of the wiper 101 (hereinafter referred to as “the wiper image”) used for generating the weather information. Then, the process goes to step S4. The detail of the processing in step S3 will be described later.

In step S4, the control unit 11 determines whether or not the wiper image candidate detected in step S3 is adopted as the wiper image used to generate the weather information. In this case, the control unit 11 analyses the wiper candidate image to determine whether or not the wiper image candidate includes the shape corresponding to the wiper 101. When it is determined that the wiper image candidate is adopted as the wiper image (step S4: Yes), the process goes to step S5. When it is determined that the wiper image candidate is not adopted as the wiper image (step S4: No), the process returns to step S3. The detail of the processing in step S4 will be described later.

In step S5, the control unit 11 generates the weather information based on the wiper image adopted in step S4. In this case, the control unit 11 generates the weather information indicating presence/absence of rainfall at the imaging place and the intensity of the rainfall, based on the movement of the wiper 101 in the images. Then, the process goes to step S6. The detail of the processing in step S5 will be described later.

In step S6, the control unit 11 acquires the position information indicating the position of the imaging place where the imaging by the camera 16 is performed. In this case, the control unit 11 acquires the position information indicating the positional coordinates of the imaging place based on the output value of the GPS receiver 23 and/or the output value of the stand-alone measurement device 24. Also, the control unit 11 associates the weather information and the position information with each other, and stores them into the storage unit 12. Then, the process goes to step S7.

In step S7, the control unit 11 determines whether or not the weather information generated in step S5 has changed. In this case, the control unit 11 determines whether or not the weather information generated in step S5 this time has changed from the weather information generated in step S5 last time. When it is determined that the weather information has not changed (step S7: No), the process returns to step S5. In this case, the control unit 11 executes the above-described processing in steps S5 to S6 again. On the contrary, when it is determined that the weather information has changed (step S7: Yes), the process goes to step S8. At the time when the weather information is generated in step S5 for the first time after the wiper imaging mode is selected in step S1, it is determined that the weather information generated this time has changed because there is no past weather information.

In step S8, the control unit 11 makes the communication unit 18 transmits, to the server apparatus 2, the weather information and the position information associated and stored in the storage unit 12 in step S6. Then, the process goes to step S9.

In step S9, the control unit 11 determines whether or not the user selected the finish of the wiper imaging mode by using the input unit 13. In this case, the control unit 11 makes the determination based on the signal outputted by the input unit 13. When it is determined that the finish of the wiper imaging mode is selected (step S9: Yes), the process ends. On the contrary, when it is determined that the finish of the wiper imaging mode is not selected (step S9: No), the process returns to step S5.

According to the flow described above, it becomes possible to appropriately generate the weather information with simple configuration. Specifically, the weather information can be appropriately generated by software processing, without using a sensor equipped in a vehicle as described in Patent Reference 1.

While only the weather information and the position information are transmitted to the server apparatus 2 in the above-described flow, the time information at which the weather information is generated may be added to the weather information and the position information to be transmitted to the server apparatus 2. Further, the image captured by the camera 16 may be added to the weather information and the position information to be transmitted to the server apparatus 2.

Also, in the above-described flow, the weather information and the position information are transmitted to the server apparatus 2 only when the weather information has changed. Namely, the weather information and the position information are not transmitted to the server apparatus 2 when the weather information has not changed. In another example, the weather information and position information may be transmitted to the server apparatus 2 with a predetermined time interval, regardless of the change of the weather information. In still another example, only the position information may be transmitted to the server apparatus 2 when the weather information has not changed. Namely, when the weather information has not changed, the weather information may be omitted and only the position information may be transmitted to the server apparatus 2. Thus, the communication amount may be reduced in comparison with the case where both the weather information and the position information are transmitted to the server apparatus 2.

2-2. Detecting Wiper Image Candidate

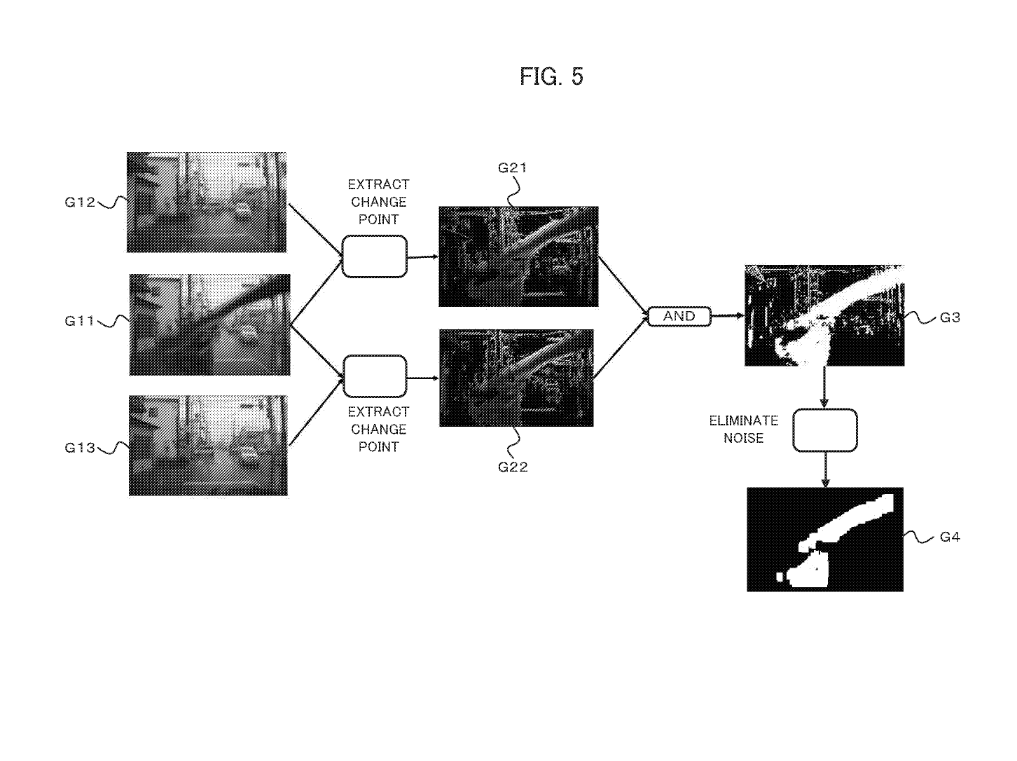

Next, with reference to FIG. 5, the description will be given of the method of detecting the wiper image candidate, executed in step S3 of FIG. 4. FIG. 5 is a diagram for explaining an example of the method of detecting the wiper image candidate.

First, the control unit 11 in the navigation apparatus 1 acquires frames, continuous in time, from the video captured by the camera 16. Then, the control unit 11 compares luminance of the pixels at the same positions between the image G11 corresponding to a reference frame serving as a reference and the image G12 corresponding to a frame immediately before the reference frame, and extracts the pixels of the image G11 whose the luminance is lower than the corresponding pixel in the image G12 by a predetermined value. Thus, the difference image G21 is produced.

Similarly, the control unit 11 compares luminance of the pixels at the same positions between the image G11 corresponding to the reference frame and the image G13 corresponding to a frame immediately after the reference frame, and extracts the pixels of the image G11 whose the luminance is lower than the corresponding pixel in the image G13 by the predetermined value. Thus, the difference image G22 is produced. The reason for extracting the pixels whose luminance is lower by the predetermined value is that the color of the wiper 101 is black and the wiper 101 blocks the external light.

Next, the control unit 11 further extracts the pixels which are extracted in both of the images G11 and G12 and the images G11 and G13. Namely, the control unit 11 calculates the logical sum (AND) of the difference image G21 and the difference image G22. Thus, the image G3 is produced.

Next, the control unit 11 repeatedly applies general contraction and expansion processing to the image G3 to eliminate the precise pattern (noise) in the image G3. Thus, the image G4 is obtained. The control unit 11 uses the part of white color in the image G4 as the wiper image candidate.

In order to produce the difference images G21 and G22 as described above, the total luminance in a block may be compared, by the unit of the blocks of vertically N pixels and horizontally M pixels in the images G11 to G13, to extract the block whose difference of the total luminance is larger than the predetermined value. By this, the burden on the arithmetic processing may be reduced, and the influence of the precise noise by the unit of the pixel may be removed.

2-3. Determination of Wiper Image Candidate

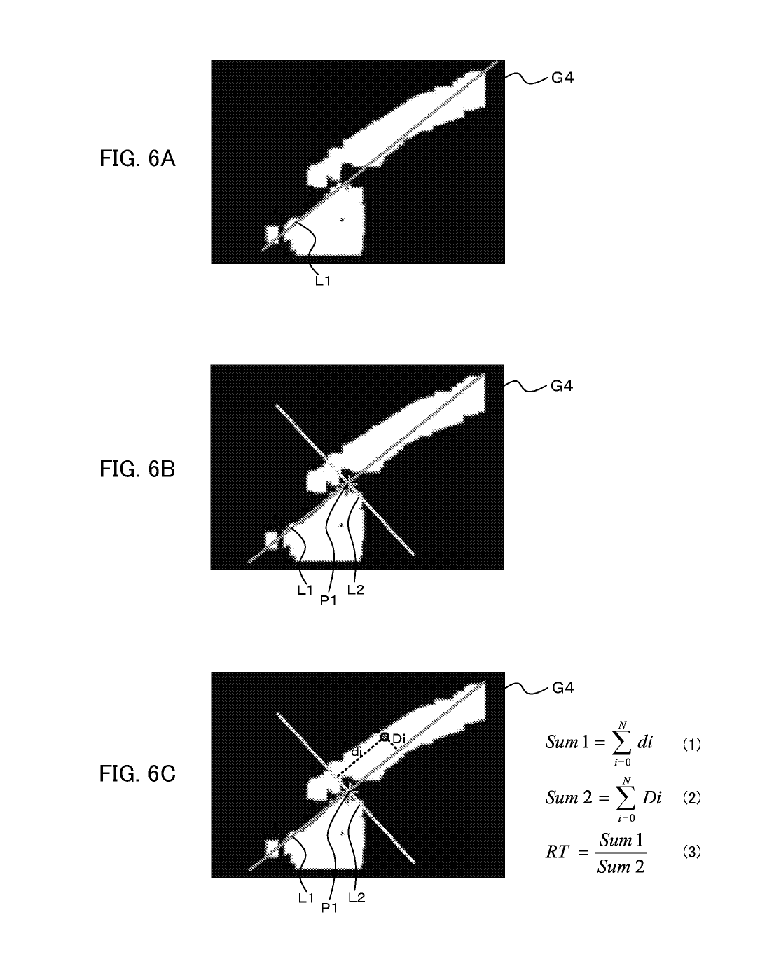

Next, with reference to FIG. 6, the description will be specifically given of a method of determining whether or not the wiper image candidate is adopted as the wiper image, executed in step S4 of FIG. 4. Namely, the method of determining whether or not the wiper image candidate has the shape corresponding to the wiper 101 will be specifically described. FIGS. 6A to 6C are diagrams for explaining an example of the method of determining the wiper image candidate.

First, as shown in FIG. 6A, the control unit 11 of the navigation apparatus 1 produces the regression line L1 for plural candidate points, based on the least square method, by using the plural pixels constituting the wiper image candidate in the image G4 produced as described above (i.e., the white part in the image G4) as the candidate points. Next, as shown in FIG. 6B, the control unit 11 produces the perpendicular line L2 which passes through the gravity center P1 of the wiper image candidate (i.e., the gravity center of the group of candidate points) and which is orthogonal to the regression line L1.

Next, as shown in FIG. 6C, the distance between the candidate point constituting the wiper image candidate and the perpendicular line L2 is defined as “di”, and the distance between the candidate point constituting the wiper image candidate and the regression line L1 is defined as “Di”. The control unit 11 produces the total sum Sum1 of the distances “di” for all the candidate points constituting the wiper image candidate by the equation (1) in FIG. 6C, and produces the total sum Sum2 of the distance “Di” for all the candidate points constituting the wiper image candidate by the equation (2) in FIG. 6C. Then, the control unit 11 produces the ratio RT between the total sum Sum1 and the total sum Sum2 by the equation (3) in FIG. 6C, and compares the ratio RT with a predetermined value to determine whether or not the wiper image candidate has the shape corresponding to the wiper 101. Comparing the ratio RT with the predetermined value corresponds to the determination of whether or not the shape of the wiper image candidate satisfies a predetermined aspect ratio.

When the ratio RT is larger than the predetermined value, the control unit 11 determines that the wiper image candidate subject to the determination has the shape corresponding to the wiper 101, and adopts the wiper image candidate as the wiper image. On the contrary, when the ratio RT is not larger than the predetermined value, the control unit 11 determines that the wiper image candidate subject to the determination does not have the shape corresponding to the wiper 101, and does not adopt the wiper image candidate as the wiper image.

According to the determination method as described above, the wiper image can be appropriately specified from the wiper image candidates. Namely, the image of the wiper 101 included in the captured images can be specified with high accuracy.

Supposing that the determination method described with reference to FIG. 6 is “first determination method”, it is possible to determine whether or not the wiper image candidate has the shape corresponding to the wiper 101 in other examples by the following determination methods (second to fourth determination methods), instead of the first determination method.

In the second determination method, the control unit 11 determines whether or not the wiper image candidate has the inclination corresponding to the wiper 101 based on whether or not the angle (inclination) of the regression line L1 produced as described above is within a predetermined range. In this example, when the angle of the regression line L1 is within the predetermined range, the control unit 11 determines that the wiper image candidate has the inclination corresponding to the wiper 101.

In the third determination method, the control unit 11 determines whether or not the wiper image candidate has the size corresponding to the wiper 101 based on whether or not the area of the wiper image candidate (uniquely the number of pixels constituting the wiper image candidate) is within the predetermined range. In this example, when the area of the wiper image candidate is within the predetermined range, the control unit 11 determines that the wiper image candidate has the size corresponding to the wiper 101.

In the fourth determination method, the control unit 11 produces the variance of the histogram in horizontal direction for the candidate points constituting the wiper image candidate, and determines whether or not the wiper image candidate has the shape corresponding to the wiper 101 based on whether or not the variance is equal to or smaller than a predetermined value. In this example, the control unit 11 determines, based on the variance, whether or not the candidate points are scattering, i.e., the candidate points forms a mass. When the variance thus produced is equal to or smaller than the predetermined value, the control unit 11 determines that the wiper image candidate has the shape corresponding to the wiper 101.

In still another example, two or more of the first to fourth determination methods may be implemented in combination.

2-4. Generating Weather Information

Next, the description will be specifically given of the method of generating the weather information, executed in step S5 of FIG. 4. The control unit 11 of the navigation apparatus 1 judges the operation condition of the wiper 101 based on the wiper image adopted by the above-mentioned determination method, and generates the weather information indicating the weather condition at the imaging place. Specifically, the control unit 11 estimates a number of times of the operation of the wiper 101 within a predetermined time period (hereinafter referred to as “the number of times of the wiper operation”) based on the movement of the wiper image in plural images captured in the predetermined time period (e.g., 20 seconds), and generates the weather information from the number of times of the wiper operation.

For example, the control unit 11 uses the number of times that the wiper image moves in the plural captured images captured in the predetermined time period as the number of times of the wiper operation. In a preferred example, the control unit 11 uses the number of times that the wiper image passes a predetermined point in the captured image (hereinafter referred to as “the number of times of the wiper passage), as the number of times of the wiper operation. For example, the predetermined point is a point in the captured image at which the wiper image necessarily passes. The reason why the wiper image is monitored for the predetermined time period is to prevent such an erroneous judgement that the wiper is operating due to the rainfall when the driver operated the wiper 101 for the reason other than the rainfall (e.g., cleaning the front glass).

In an example, the control unit 11 generates the weather information indicating either “Rain” or “No Rain”. In this example, the control unit 11 generates the weather information indicating “Rain” when the number of times of the wiper passage is larger than a predetermined number of times (e.g., 5 times), and generates the weather information indicating “No Rain” when the number of times of the wiper passage is not larger than the predetermined number of times.

In another example, the control unit 11 generates the weather information indicating the rainfall intensity as the weather condition. In this example, the control unit 11 generates the weather information indicating one of “Small Rain”, “Medium Rain”, “Heavy Rain” and “No Rain”. For example, the control unit 11 generates the weather information indicating “No Rain” when the number of times of the wiper passage is not larger than 5 times, generates the weather information indicating “Small Rain” when the number of times of the wiper passage is between 6 to 10 times, generates the weather information indicating “Medium Rain” when the number of times of the wiper passage is between 11 to 19 times, and generates the weather information indicating “Heavy Rain” when the number of times of the wiper passage is equal to or larger than 20 times.

According to the method of generating the weather information as described above, the weather information can be appropriately generated based on the images of the wiper 101 captured by the camera 16, without using a sensor provided in the vehicle.

By the way, the frame rate of the video imaged by the camera 16 may be changed in accordance with the brightness of the object of imaging. For example, when the object of imaging is dark, the camera 16 lowers the shutter speed in order to achieve sufficient exposure. In this case, the frame rate of the video becomes low. In such a situation, since the interval of the successive frames becomes long, the wiper 101 is sporadically captured only in one frame even if the wiper 101 is moving, or the wiper 101 is not captured in the image because the wiper 101 passes during the interval.

Therefore, in another example, in order to overcome the above deficiency, the control unit 11 estimates the number of times that the wiper image is included in the plural captured images (hereinafter referred to as “the number of times of capturing the wiper”), instead of the number of times that the wiper image moves in the plural images captured in the predetermined time period (i.e., the number of times of wiper passage). More specifically, the control unit 11 estimates the number of times of the wiper operation from the number of times of the capturing the wiper, based on the frame rate of the video imaged by the camera 16. For example, a table associating the frame rate, the number of times of capturing the wiper and the number of times of the wiper operation is prepared in advance, and the control unit 11 refers to the table to acquire the number of times of the wiper operation corresponding to the frame rate and the number of times of capturing the wiper at present. In addition, the control unit 11 sets a predetermined time period (hereinafter referred to as “the monitoring time period”) for monitoring the movement of the wiper 101 in accordance with the frame rate of the video taken by the camera 16. Specifically, the control unit 11 sets the monitoring time period longer as the frame rate is lower. According to the example described above, the number of times of the wiper operation can be accurately estimated, regardless of the frame rate of the video taken by the camera 16.

2-5. Processing of Server

Next, the description will be specifically given of the processing executed by the control unit 21 in the server apparatus 2. The control unit 21 in the server apparatus 2 generates a map of the weather condition associated with the map data stored in the storage unit 22 (hereinafter referred to as “the weather map”), based on the weather information and the position information received from the navigation apparatus 1 via the communication unit 23. In this case, the control unit 21 generates the weather map indicating the weather condition of the areas obtained by dividing the map into predetermined areas (e.g., an area of 500×500 m), based on the weather information and the position information received from the plural navigation apparatuses 1.

Specifically, the control unit 21 generates the weather map by assigning the weather condition indicating the received weather information (i.e., the information indicating “Rain” or “No Rain”, or the information indicating one of “Small Rain”, “Medium Rain”, “Heavy Rain” and “No Rain”) to the area corresponding to the received position information. Then, the control unit 21 transmits the generated weather map in response to the request from a predetermined terminal device (including the navigation apparatus 1).

In an example, the control unit 21 generates the weather map by assigning the weather condition of the largest number, among the weather conditions indicated by the weather information received from the plural navigation apparatuses 1 for the same area, to the area. In another example, the control unit 21 generates the weather map by assigning the newest weather condition, among the weather conditions indicated by the weather information received from the plural navigation apparatuses 1 for the same area, to the area.

According to the processing of the server apparatus 2 as described above, the weather map indicating the weather condition of each area can be appropriately generated by collecting the weather information received from the navigation apparatuses 1 installed in the plural vehicles 100.

### 3. SECOND EMBODIMENT

Next, the second embodiment will be described. In the following, the configuration (the processing, the control or else) different from the first embodiment will be described. The configuration of the first embodiment that is not mentioned here can be appropriately implemented in combination with the second embodiment.

In the first embodiment, the weather information is generated and transmitted to the server apparatus 2 only when the movement of the wiper 101 changes (see. FIG. 4). In the second embodiment, the weather information is generated and transmitted to the server apparatus 2 with a predetermined time interval, regardless of the change of the movement of the wiper 101. Specifically, in the second embodiment, the control unit 11 in the navigation apparatus 1 further generates the information indicating how the weather has changed (or has not changed) (hereinafter referred to as “the weather change information”) based on the new weather information generated this time and the past weather information stored in the storage unit 12, and also transmits the weather change information to the server apparatus 2. In this case, the control unit 11 generates the information indicating “Start Raining”, “Rain Continuing”, “Stop Raining” and “No Rain Continuing”, as the weather change information.

It is not limited to generate the weather change information separately from the weather information, the weather change information may be generated in a manner included in the weather information. In that case, the weather information including the weather change information is transmitted to the server apparatus 2. In the following, the description will be given of the case where the weather change information is generated in a manner included in the weather information.

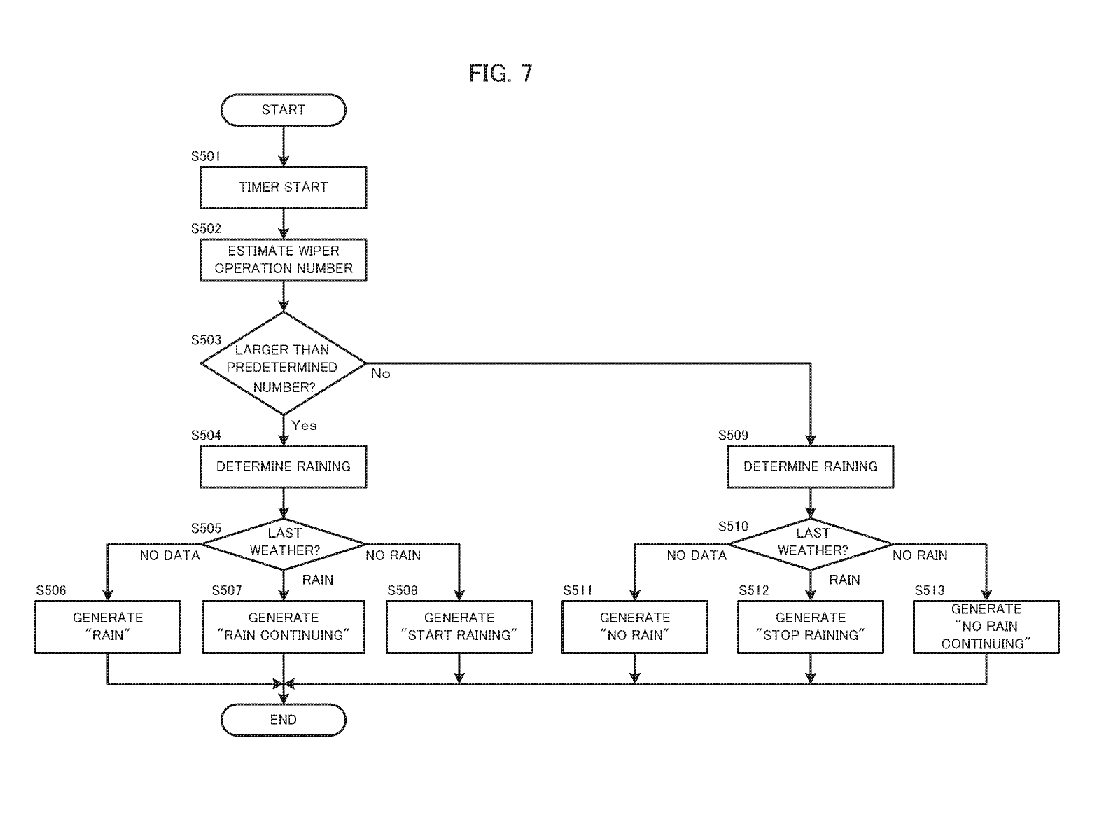

FIG. 7 is a flowchart illustrating the method of generating weather information according the second embodiment. This flow is executed in step S5 of FIG. 4 by the control unit 11 in the navigation apparatus 1. In this flow, the control unit 11 generates the weather information including the weather change information.

First, in step S501, the control unit 11 starts the timer. Then, in step S502, the control unit 11 estimates the number of times of the wiper operation in the predetermined time period. Specifically, the control unit 11 estimates the number of times of the wiper operation in the predetermined time period based on the movement of the wiper image adopted from the wiper image candidates by the method described in the sections “2-2. Detecting Wiper Image Candidate” and “2-3. Determination of Wiper Image Candidate”. In this case, the control unit 11 estimates the number of times of the wiper operation by the method described in “2-4. Generating Weather Information”. Specifically, the control unit 11 estimates the number of times of the wiper operation based on the number of times (i.e., the number of times of the wiper passage) that the wiper image moves in the plural images captured in the predetermined time period or the number of times that the wiper image is included in the plural images (i.e., the number of times of capturing the wiper). Then, the process goes to step S503.

In step S503, the control unit 11 determines whether or not the number of times of the wiper operation is larger than a predetermined number of times (e.g. 5 times). When the number of times of the wiper operation is larger than the predetermined number of times (step S503: Yes), the control unit 11 determines that the rain is falling this time (step S504). Then, the control unit 11 determines the weather information of the last time (step S505). When there is no weather information of the last time, the control unit 11 generates the weather information indicating “Rain” (step S506). When the weather information of the last time is “Rain”, the control unit generates the weather information indicating “Rain Continuing” (step S507). When the weather information of the last time is “No Rain”, the control unit 11 generates the weather information indicating “Start Raining” (step S507). Then, the process ends after the steps S506 to S508.

On the other hand, when the number of times of the wiper operation is not larger than the predetermined number of times (step S503: No), the control unit 11 determines that the rain is not falling this time (step S509). Then, the control unit 11 determines the weather information of the last time (step S510). When there is no weather information of the last time, the control unit 11 generates the weather information indicating “No Rain” (step S511). When the weather information of the last time is “Rain”, the control unit 11 generates the weather information indicating “Stop Raining” (step S512). When the weather information of the last time is “No Rain”, the control unit 11 generates the weather information indicating “No Rain Continuing” (step S513). Then, the process ends after the steps S511 to S513.

According to the flow described above, the weather information including the weather change information can be appropriately generated. By the weather information, it is possible to appropriately grasp how the weather has changed (or the weather has not changed). Specifically, by transmitting the weather information including the weather change information as well as the position information and the time information to the server apparatus 2, the server apparatus 2 can efficiently organize when and where the rain began and when and where the rain stopped.

In another example, the monitoring time period for which the movement of the wiper 101 is monitored and/or the interval for which the movement of the wiper 101 is monitored (hereinafter referred to as “the monitoring interval”) may be changed in accordance with the weather information generated this time. For example, it is preferred to extend the monitoring time period or shorten the monitoring interval when the weather information indicating “Stop Raining” is generated. By this, the end of the raining may be accurately determined.

In still another example, the server apparatus 2 may generate the weather change information. In that case, the navigation apparatus 1 generates and transmits the weather information which does not include the weather change information, and the server apparatus 2 compares the weather information received this time with the weather information received last time (stored in the storage unit 22) to generate the weather change information indicating how the weather has changed (or the weather has not changed).

### 4. THIRD EMBODIMENT

Next, the third embodiment will be described. In the following, the configuration (the processing, the control or else) different from the f first and the second embodiment will be described. The configuration of the first and the second embodiment that is not mentioned here can be appropriately implemented in combination with the third embodiment.

The third embodiment is different from the first and the second embodiment in that the weather information is not transmitted to the server apparatus 2 when the vehicle 100 is travelling in a tunnel, under a viaduct and in an indoor parking. In this case, the control unit 11 in the navigation apparatus 1 determines whether or not the vehicle 100 is travelling in a tunnel, under a viaduct and in an indoor parking based on the measurement data by the GPS receiver 14 and the data of the tunnel, the viaduct and the indoor parking stored as the map data. Then, when the control unit 11 determines that the vehicle 100 is travelling in a tunnel, under a viaduct or in an indoor parking, it does not transmit the weather information to the server apparatus 2. By this, it becomes possible to appropriately prevent the erroneous information from being transmitted to the server apparatus 2. Specifically, when the vehicle 100 is travelling in a tunnel, under a viaduct or in an indoor parking, the wiper 101 is not operated even if it is raining. In that case, it is possible to prevent the weather information indicating “No Rain” from being transmitted even though it is raining.

When the weather information is not transmitted to the server apparatus 2 as described above, i.e., when it is determined that the vehicle is travelling in a tunnel, under a viaduct or in an indoor parking, it is both OK that the weather information is generated and the weather information is not generated.

When the vehicle 100 is travelling in a tunnel, under a viaduct or in an indoor parking, it is highly possible that the GPS receiver 14 cannot receive the radio waves. Therefore, in still another example, when the GPS receiver 14 is not receiving the radio waves (or when the radio wave intensity of the GPS receiver 14 is smaller than a predetermined value), it may be determined that the vehicle 100 is travelling in a tunnel, under a viaduct or in an indoor parking, and transmitting the weather information to the server apparatus 2 may be stopped.

In the above example, when the vehicle is travelling in a tunnel, under a viaduct or in an indoor parking, the weather information is not transmitted. Instead, in still another example, information indicating that the vehicle 100 is travelling in a tunnel, under a viaduct or in an indoor parking may be added to the weather information to be transmitted to the server apparatus 2. When receiving the information indicating that the vehicle 100 is travelling in a tunnel, under a viaduct or in an indoor parking, the server apparatus 2 does not use the weather information for generating the weather map.

In still another example, the server apparatus 2 may determine whether or not the vehicle 100 is travelling in a tunnel, under a viaduct or in an indoor parking. In that case, the navigation apparatus 1 always transmits the weather information and the position information to the server apparatus 2, and the server apparatus 2 does not use the weather information for the purpose of generating the weather map when it is determined that the vehicle 100 is travelling in a tunnel, under a viaduct or in an indoor parking. For example, the server apparatus 2 determines whether or not the vehicle 100 is travelling in a tunnel, under a viaduct or in an indoor parking based on the data of the tunnel, the viaduct and the indoor parking stored in the storage unit 22 as the map data.

### 5. FOURTH EMBODIMENT

Next, the fourth embodiment will be described. In the following, the configuration (the processing, the control or else) different from the first to third embodiments will be described. The configuration of the first to third embodiments that is not mentioned here can be appropriately implemented in combination with the fourth embodiment.

The fourth embodiment is different from the first to third embodiments in that the number of times of the wiper operation described above is corrected in accordance with the travelling speed of the vehicle 100 and the weather information is generated based on the number of times of the wiper operation thus corrected. Specifically, in the fourth embodiment, the control unit 11 in the navigation apparatus 1 produces the number of times of the wiper operation corresponding to the stopped state of the vehicle 100 (hereinafter referred to as “the number of times at the stopped state”) by correcting the number of times of the wiper operation estimated by the method described in “2-4. Generating Weather Information” in accordance with the travelling speed. Then, the control unit 11 generates the weather information indicating the intensity of the rainfall based on the number of times at the stopped state thus produced. The control unit 11 obtains the travelling speed of the vehicle 100 based on the output value of the GPS receiver 14 and/or the output value of the stand-alone measurement device 15, or by acquiring the vehicle speed pulse information from the vehicle 100.

The reason for correcting the number of times of the wiper operation as described above is as follows. When the travelling speed increases, the number of raindrops hit on the front glass increases, and therefore the driver tends to increase the operation speed of the wiper 101. Thus, the estimated number of times of the wiper operation becomes larger. Accordingly, in order to accurately generate the weather information indicating the intensity of the rainfall, it is desired that the number of times of the wiper operation is corrected to the number of times corresponding to the vehicle stopped state in accordance with the travelling speed at that time. Therefore, in the fourth embodiment, the control unit 11 corrects the number of times of the wiper operation in accordance with the travelling speed.

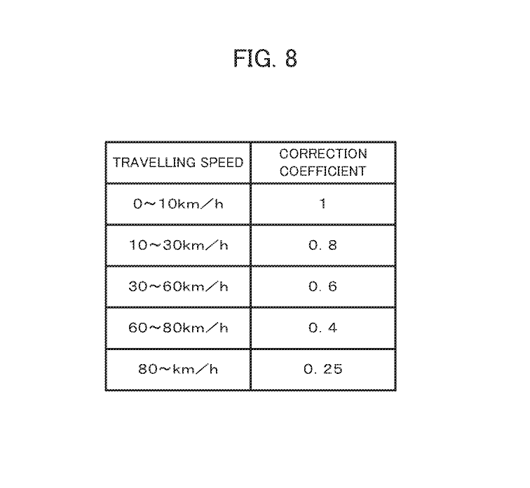

For example, the control unit 11 corrects the number of times of the wiper operation by the correction coefficient shown in FIG. 8. FIG. 8 shows a table of the correction coefficients (a correction coefficient table), for each of the travelling speed ranges, used to correct the number of times of the wiper operation to the number of times corresponding to the vehicle stopped state. This correction coefficient table is obtained by the experiment or simulation in advance and is stored in the storage unit 12. For example, it is assumed that the number of times of the wiper operation “20 times” is obtained at the travelling speed 100 km/h. In that case, the control unit 11 refers to the correction coefficient table to obtain the correction coefficient “0.25” corresponding to 100 km/h, and corrects the number of times of the wiper operation by the arithmetic operation “20 times×0.25” to obtain the number of times corresponding to the vehicle stopped state “5 times”.

As described above, by using the number of times corresponding to the vehicle stopped state obtained by correcting the number of times of the wiper operation, the weather information indicating the intensity of the rainfall can be accurately generated.

In another example, the correction coefficient table different for each vehicle type may be used. In that case, the control unit 11 accepts the registration of the vehicle type by the user, obtains the correction coefficient table corresponding to the registered vehicle type, and corrects the number of times of the wiper operation based on the correction coefficient table. The reason why the correction coefficient table according to the vehicle type is used is that the correction coefficient for correcting the number of times of the wiper operation to the number of times corresponding to the vehicle stopped state in accordance with the vehicle speed tends to be different dependently upon the vehicle type. For example, the tendency for the raindrops to be blown during the traveling is different dependently upon the degree of the front glass inclination for each vehicle type, and it may be unnecessary for a certain type of vehicle to increase the operation speed of the wiper 101 at the high speed travelling (i.e., it may be unnecessary to largely correct the number of times of the wiper operation at the high speed travelling, according to the vehicle type). The correction coefficient table for each vehicle type is produced by an experiment or a simulation in advance, and is stored in the storage unit 12.

In still another example, different correction coefficient table may be used in accordance with the presence or absence of the water repelling coating of the front glass. In that case, the control unit 11 accepts the registration as to whether or not the water repelling coating is applied to the front glass, obtains the correction coefficient table in accordance with the present or absence of the water repelling coating thus registered, and corrects the number of times of the wiper operation based on the correction coefficient table. Such a correction coefficient table is produced by an experiment or a simulation in advance, and is stored in the storage unit 12.

In still another example, the correction coefficient table described above may be stored, not in the storage unit 12 of the navigation apparatus 1, but in the storage unit 22 of the server apparatus 2. In that case, the navigation apparatus 1 accepts the registration of information necessary for obtaining the correction coefficient table, and transmits the information to the server apparatus 2. The server apparatus 2 reads out the correction coefficient table corresponding to the information thus transmitted from the navigation apparatus 1, and transmits the correction coefficient table to the navigation apparatus 1.

In still another example, instead of producing the number of times of the wiper operation by analyzing the images captured by the camera 16 as described above, the condition of the wiper operation may be acquired from an on-vehicle network such as a CAN (Controller Area Network). For example, the navigation apparatus 1 acquires information indicating which one of the interval operation, the normal operation and the high speed operation the wiper 1 is set to, as the wiper operation condition. In that case, the control unit 11 in the navigation apparatus 1 generates the weather information based on the acquired wiper operation condition and the travelling speed of the vehicle 100. Specifically, the control unit 11 corrects the number of times of the wiper operation corresponding to the wiper operation condition by the correction coefficient in accordance with the travelling speed to generate the weather information indicating the intensity of the rainfall.

### 6. MODIFIED EXAMPLES

While the weather information is generated on the navigation apparatus 1 side in the embodiment described above, the weather information may be generated on the server apparatus 2 side. In that case, the navigation apparatus 1 generates the wiper information about the movement of the wiper 101 based on the images taken by the camera 16, and transmits the wiper information and the position information indicating the position of the imaging place by the camera 16 to the server apparatus 2. Then, the server apparatus 2 generates the weather information at the imaging place based on the wiper information and the position information received from the navigation apparatus 1. Namely, the server apparatus 1 detects the weather condition at the imaging place. For example, the navigation apparatus 1 generates the number of times of the wiper operation as the wiper information, and the server apparatus 2 generates the weather information indicating “Rain” or “No Rain” based on the number of times of the wiper operation.

In still another example, the navigation apparatus 1 may transmit the travelling speed of the vehicle 100 to the server apparatus 2 in addition to the wiper information and the position information, and the server apparatus 2 may correct the wiper information (e.g., the number of times of the wiper operation) in accordance with the received travelling speed to generate the weather information based on the wiper information thus corrected.

While the present invention is applied to the navigation apparatus 1 in the embodiment described above, the application of the present invention is not limited to this. Other than the navigation apparatus 1, the present invention is applicable to a portable terminal (e.g., a smartphone) capable of measuring the self-position, and a drive recorder. Namely, “the information transmission apparatus” according to the present invention may be applied to such a portable terminal or a drive recorder.

### DESCRIPTION OF REFERENCE NUMBERS

1 Navigation Apparatus

2 Server Apparatus

11, 21 Control Unit

12, 33 Storage Unit

13 Input Unit

14 GPS Receiver

15 Stand-alone Measurement Unit

16 Camera

17 Display Unit

18, 23 Communication Unit

100 Vehicle

101 Wiper

1. An information transmission apparatus which moves with a movable body, comprising:
an imaging unit;
a weather information generation unit which generates weather information indicating weather condition at an imaging place by the imaging unit, based on images of a wiper of the movable body taken by the imaging unit;
an acquisition unit which acquires position information of the imaging place; and
a transmission unit which transmits the weather information and the position information.

2. The information transmission apparatus according to claim 1, wherein the weather information generation unit generates the weather information based on a number of times that the wiper moves in plural images taken by the imaging unit during a predetermined time or a number of times that the wiper is included in the plural images.

3. The information transmission apparatus according to claim 1, wherein the weather information generation unit generates information on intensity of rainfall as the weather information.

4. The information transmission apparatus according to claim 1, further comprising a storage unit which stores the weather information,
wherein the weather information generation unit further generates information on weather change based on current weather information generated this time and past weather information stored in the storage unit, and
wherein the transmission unit transmits the weather information, the position information and the information on weather change.

5. The information transmission apparatus according to claim 1, wherein the transmission unit does not transmit the weather information when the movable body is travelling in a tunnel, under a viaduct or in an indoor parking.

6. The information transmission apparatus according to claim 1, wherein, when the movable body is travelling in a tunnel, under a viaduct or in an indoor parking, the transmission unit transmits information indicating that the movable body is travelling in a tunnel, under a viaduct or in an indoor parking, in addition to the weather information and the position information.

7. The information transmission apparatus according to claim 1, wherein the weather information generation unit compares successive images taken by the imaging unit to specify the image, included in an area where luminance of pixels decrease more than a predetermined value, as a wiper image candidate which is a candidate for the image of the wiper.

8. The information transmission apparatus according to claim 7, wherein the weather information generation unit adopts the wiper image candidate as the image of the wiper in a case where a shape of the wiper image candidate satisfies a predetermined aspect ratio.

9. The information transmission apparatus according to claim 7, wherein the weather information generation unit adopts the wiper image candidate as the image of the wiper in a case where inclination of a shape of the wiper image candidate is within a predetermined angle range.

10-11. (canceled)

12. An information transmission method executed by an information transmission apparatus which includes an imaging unit and which moves with a movable body, comprising:
a weather information generation process which generates weather information indicating weather condition at an imaging place by the imaging unit, based on images of a wiper of the movable body taken by the imaging unit;
an acquisition process which acquires position information of the imaging place; and
a transmission process which transmits the weather information and the position information.

13. A computer program product stored in a non-transitory tangible computer-readable medium and executed by an information transmission apparatus which includes an imaging unit and a computer and which moves with a movable body, the computer program product, when operated, causing the computer function as:
a weather information generation unit which generates weather information indicating weather condition at an imaging place by the imaging unit, based on images of a wiper of the movable body taken by the imaging unit;
an acquisition unit which acquires position information of the imaging place; and
a transmission unit which transmits the weather information and the position information.

14. (canceled)

15. The information transmission apparatus according to claim 2, wherein the weather information generation unit generates information on intensity of rainfall as the weather information.

16. The information transmission apparatus according to claim 2, further comprising a storage unit which stores the weather information,
wherein the weather information generation unit further generates information on weather change based on current weather information generated this time and past weather information stored in the storage unit, and
wherein the transmission unit transmits the weather information, the position information and the information on weather change.

17. The information transmission apparatus according to claim 3, further comprising a storage unit which stores the weather information,
wherein the weather information generation unit further generates information on weather change based on current weather information generated this time and past weather information stored in the storage unit, and
wherein the transmission unit transmits the weather information, the position information and the information on weather change.

18. The information transmission apparatus according to claim 2, wherein the transmission unit does not transmit the weather information when the movable body is travelling in a tunnel, under a viaduct or in an indoor parking.

19. The information transmission apparatus according to claim 3, wherein the transmission unit does not transmit the weather information when the movable body is travelling in a tunnel, under a viaduct or in an indoor parking.

20. The information transmission apparatus according to claim 4, wherein the transmission unit does not transmit the weather information when the movable body is travelling in a tunnel, under a viaduct or in an indoor parking.

21. The information transmission apparatus according to claim 2, wherein, when the movable body is travelling in a tunnel, under a viaduct or in an indoor parking, the transmission unit transmits information indicating that the movable body is travelling in a tunnel, under a viaduct or in an indoor parking, in addition to the weather information and the position information.

22. The information transmission apparatus according to claim 3, wherein, when the movable body is travelling in a tunnel, under a viaduct or in an indoor parking, the transmission unit transmits information indicating that the movable body is travelling in a tunnel, under a viaduct or in an indoor parking, in addition to the weather information and the position information.

23. The information transmission apparatus according to claim 4, wherein, when the movable body is travelling in a tunnel, under a viaduct or in an indoor parking, the transmission unit transmits information indicating that the movable body is travelling in a tunnel, under a viaduct or in an indoor parking, in addition to the weather information and the position information.
